(19) United States
(12) Patent Application Publication
(10) Pub. No.: US 2005/0194933 A1
(43) Pub. Date: Sep. 8, 2005

(54) Method of charging a battery

(76) Inventors: Edward H. Arnold, Phoenixville, PA (US); Bruce J. Rogers, Lansdale, PA (US)

Correspondence Address: RATNERPRESTIA, P O BOX 980, VALLEY FORGE, PA, 19482-0980, US

(21) Appl. No.: 10/791,122

(22) Filed: Mar. 2, 2004

(51) Int. Cl. H02J 7/00

(52) U.S. Cl. 320/128

(57) ABSTRACT

A method of charging a battery having an internal resistance and an external resistance connected to the battery includes applying electrical energy to the battery. The method also includes adjusting, at a plurality of predetermined intervals, the electrical energy applied to the battery based on at least one of the internal resistance of the battery and the external resistance connected to the battery.

### FIELD OF THE INVENTION

The present invention relates to charging a battery, and more particularly, to charging a battery by dynamically compensating for resistance associated with the battery.

### BACKGROUND OF THE INVENTION

As the use of portable powered devices increases (e.g., portable battery operated electronic devices, cordless power tools, etc.), interest in varying battery technologies has also increased. For example, lithium-based (e.g., lithium-ion, lithium-polymer, etc.) batteries have become increasingly popular in battery powered portable electronics equipment (e.g., cameras, laptop PCs, cordless telephones, cellular telephones, personal digital assistants (PDAs), etc.).

When used in these applications, lithium-based battery technology possesses certain technological advantages over alternate technologies such as a high volumetric efficiency and a high mass efficiency. More specifically, for a given weight and volume, lithium-based batteries are capable of storing more electrical energy than batteries using many other readily available battery cell chemistries. Further, lithium-based batteries have a low rate of self-discharge. This means that in comparison to other technologies, lithium-based batteries retain charge well during storage.

Although lithium-based batteries may be more costly than certain other batteries (e.g., nickel-cadmium (Ni—Cd) and nickel-metal-hydride batteries (Ni-MH)), they are not prohibitively expensive for use in certain products.

The nature of lithium-based batteries results in the charging of lithium-based batteries typically using different methodologies from those used with respect to other battery cell chemistries. For example, attempting to charge lithium-based batteries beyond 4.2 volts per cell may permanently damage the battery and may even result in an explosion of the battery. Further, over discharging lithium-based batteries may also result in irreversible changes to the batteries. Thus, manufacturers often incorporate semiconductor-based protection circuitry in the lithium battery pack to prevent overcharging and/or over discharging. Additionally, lithium-based batteries that supply excessive output current may be damaged (or even explode), and as such, manufacturers often incorporate an overcurrent protection device (e.g., a PTC fuse) within the battery pack. PTC fuses are thermistor type devices that exhibit a relatively low resistance at rated current. The resistance, however, increases exponentially above the rated current.

Typical charging methods used for charging lithium-based batteries include a phase where the batteries are charged at a constant current (e.g., a 1C to 1½C charging rate). At a 1C charging rate, a 1 ampere/hour battery would be charged at a constant current of 1 amp. Likewise, at a 1½C charging rate, a 1 ampere/hour battery would be charged at a constant current of 1½ amps. When a cell voltage of 4.2 volts is reached, the constant current is adjusted to maintain a substantially constant 4.2 volts (i.e., the battery has entered a constant voltage phase of the charging cycle). During the constant voltage phase, the current is monitored until it reaches a fraction (e.g., 1/10^{th}) of its initial value. At this current value, the battery is considered to be fully charged. If a lithium-based battery is discharged to its low voltage limit, and then fully charged as described above, the charging cycle typically takes 2½ to 3½ hours.

Unfortunately, such a charging cycle duration (i.e., 2½ to 3½ hours) is excessive in comparison to charging times for nickel-cadmium and nickel-metal-hydride batteries. For example, Ni-MH batteries can be charged in approximately 1 hour, where the limitation on charging time is related to their exothermic charging characteristics. Ni—Cd batteries may be charged in an even shorter time period (e.g., approximately 15 minutes) as they possess an endothermic charging characteristic.

Thus, the relatively long charging cycle of lithium-based batteries as compared to other battery chemistries is one of their less desirable characteristics.

Another undesirable characteristic of lithium-based batteries is known as “capacity fade.” More specifically, each time a lithium-based battery is charged it loses a small percentage of its storage capacity. While all battery chemistries exhibit some level of capacity fade, lithium-based batteries fade more rapidly than other battery technologies such as Ni—Cd and Ni-MH.

Thus, it would be desirable to provide battery charging methods and systems that overcome one or more of the above-mentioned deficiencies.

### SUMMARY OF THE INVENTION

The present invention involves a method of charging a battery having an internal resistance and an external resistance connected to the battery. The method includes applying electrical energy to the battery. The method also includes adjusting, at a plurality of predetermined intervals, the electrical energy applied to the battery based on at least one of the internal resistance of the battery and the external resistance connected to the battery.

According to another exemplary embodiment of the present invention, a computer readable carrier including computer program instructions for implementing the above-described method of charging a battery is provided.

According to yet another exemplary embodiment of the present invention, an electronic device is provided. The electronic device includes a battery and a computer readable carrier. The computer readable carrier includes computer program instructions for implementing the above-described method of charging a battery.

According to yet another exemplary embodiment of the present invention, an electronic device is provided. The electronic device includes a battery having an internal resistance and an external resistance connected to the battery. The electronic device also includes processor. The processor controls an electrical energy source for applying electrical energy to the battery. Further, the processor adjusts, after each of a plurality of predetermined intervals, the electrical energy applied to the battery based on at least one of the internal resistance of the battery and the external resistance connected to the battery.

### BRIEF DESCRIPTION OF THE DRAWINGS

Exemplary embodiments of the invention will be described with reference to the drawings, of which:

FIG. 1 is a block diagram illustrating elements of a lithium battery pack in accordance with an exemplary embodiment of the present invention;

FIG. 2 is a flow diagram illustrating a method of charging a battery in accordance with an exemplary embodiment of the present invention;

FIG. 3 is a block diagram illustrating elements of a control system for charging a battery in accordance with an exemplary embodiment of the present invention;

FIG. 4 is a flow diagram illustrating a method of charging a battery in accordance with an exemplary embodiment of the present invention;

FIG. 5 is a schematic of a portion of a control system for charging a battery in accordance with an exemplary embodiment of the present invention;

FIG. 6A is a block diagram of an electronic device in accordance with an exemplary embodiment of the present invention; and

FIG. 6B is a block diagram of another electronic device in accordance with another exemplary embodiment of the present invention.

### DETAILED DESCRIPTION OF THE INVENTION

Preferred features of embodiments of this invention will now be described with reference to the figures. It will be appreciated that the spirit and scope of the invention is not limited to the embodiments selected for illustration. It is contemplated that any of the configurations and materials described hereafter can be modified within the scope of this invention.

U.S. Pat. No. 5,600,226 relates to battery charging techniques and is incorporated by reference herein for its teachings related to batteries and battery charging.

In relation to the battery charging methods described herein, electrical energy is applied to the battery. For example, during a constant current phase of a charging cycle, this electrical energy may be viewed as being supplied by a constant current source. Conversely, during a constant voltage phase of a charging cycle, this electrical energy may be viewed as being supplied by a constant voltage source. It is contemplated that the electrical energy may be any type of energy used to charge a battery, regardless of whether the energy is viewed as being supplied by a current source, a voltage source, etc.

Further, the electrical energy applied to the battery is dynamically adjusted according to the present invention to compensate for certain resistances associated with the battery. This adjustment may be accomplished in a number of ways. For example, if it is desired to adjust the electrical energy while maintaining a constant current, the width of the charging pulse may be adjusted/modulated. This is only an example, however, and any of a number of other electrical energy adjustment techniques may be used.

The present invention compensates for a voltage drop over a number of resistances related to a battery to be charged. These resistances may be generally defined as internal resistances (e.g., the internal cell resistance) and external resistances (e.g., terminal resistances, lead resistances, protective device resistances, etc.). These sources are not necessarily resistive in nature. For example, the voltage drop may be caused by a capacitive or inductive load rather than a resistive load. Further, the load may be a combination of resistive, capacitive, and/or inductive loads. Regardless, the term resistance or resistor is intended to contemplate any type of impedance which causes a voltage drop in the battery circuit.

The present invention is described herein largely as a method of charging a battery through which compensation for certain resistance values is made. The actual resistance values may not necessarily be determined. Rather, other methods of compensating for the resistances, without actually determining the resistances, are also contemplated. For example, a voltage drop associated with a number of resistance values may be determined and compensated for. Thus, regardless of whether the actual resistance values are determined, some means of compensating for the resistances is provided.

In an exemplary embodiment of the present invention, charging cycle times for batteries (e.g., lithium-based batteries) are reduced by dynamically compensating for internal and external resistances related to the battery during the charging cycle. As part of this process, battery voltage is measured at a time when no current is flowing into or out of the battery. Through this technique, the actual cell voltage may be measured without the inaccuracies introduced by a number of series resistances related to the battery, as detailed herein. Additionally, the current flowing into the battery, as well as the voltage at the output of the charger, are measured during charging. With this additional information, the actual voltage drop across the series resistances can be calculated and subsequently compensated for. As a result, the onset of the constant voltage phase of charging can be delayed until the actual battery voltage reaches approximately 4.2 volts/cell. As cell resistance is dynamically changing during the charging cycle, the actual battery voltage is re-calculated at predetermined intervals (e.g., once per second).

In accordance with another exemplary embodiment of the present invention, to minimize the effects of cell resistance, a short (e.g., 5 millisecond) but deep (e.g., 2½C) discharge pulse is applied to the battery at a predetermined interval (e.g., once per second). This technique redistributes the charge more uniformly over the surface of the battery plates, preventing the formation of bubbles, and minimizing cell resistance. The plates of the battery are not a flat sheet of metal. Rather, they are typically highly irregular in order to maximize their surface area and keep cell resistance low. As charge tends to reside on the peaks of this surface, the peaks enter an overcharge state long before the battery is fully charged. As this is an electrolytic process, these overcharged peaks tend to evolve oxygen bubbles that shield the rest of the plates from being charged.

The discharge pulse discharges this excessive charge at the peaks and results in the battery being more uniformly charged. As no bubbles are present, cell resistance remains low and the battery will accept charge at a higher rate. Since lithium-based batteries are highly susceptible to damage from overcharging, the discharge pulsing minimizes this effect and results in a much lower rate of capacity fade.

Thus, instead of arbitrarily limiting charging voltage of a battery to rated voltage (e.g., 4.2 volts/cell), the target charging voltage is modified dependent on the actual value of internal and external cell resistances to provide a constant current or a constant effective cell voltage of the rated voltage (e.g., 4.2 volts/cell) at the cell side of this internal resistance. The net effect of this dynamic compensation technique is a substantial reduction in battery charging times. As the battery's internal resistance changes as it approaches full charge, the cell resistance is recalculated at a predetermined interval (e.g., once per second). Termination of the charging cycle typically occurs when charging current falls to a predetermined percentage (e.g., 10%) of the constant current setting during the constant voltage phase of the charging cycle.

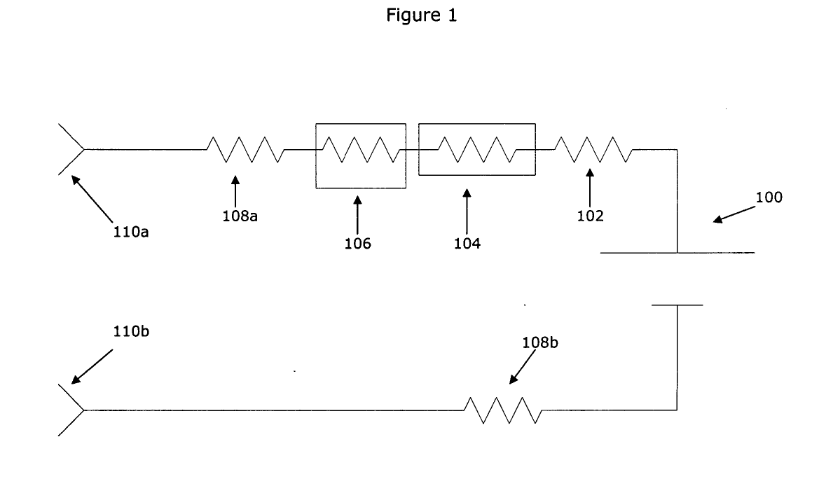

FIG. 1 is a block diagram of an electrical model of a lithium-based battery pack, modeled as an ideal battery 100 in series with a number of resistances and battery terminals 110a and 110b. A number of external resistances (i.e., 104, 106, 108a, and 108b) are illustrated and modeled as being in series with battery 100. Each of these external resistances, along with internal cell resistance 102 of battery 100, make it difficult to accurately measure battery voltage in order to control the charging cycle.

Certain of these resistances relate to protection devices (e.g., cell protection device 104, overcurrent protection device 106) included in a lithium-based battery pack. Terminal and lead resistances 108a and 108b, and internal cell resistance 102, may be present in any type of battery pack. In certain types of batteries (e.g., Ni—Cd or Ni-MH batteries), these resistances are less important because such batteries are charged using a constant current source until the charge cycle is terminated. Lithium-based batteries are limited by the maximum cell voltage.

Through an exemplary series of laboratory measurements related to a typical lithium cell (a 4.2 volt lithium cell, such as that used in a cellular telephone), the combined resistance of terminal and lead resistances 108a and 108b measured 0.0536 Ω (resulting in a voltage drop of 0.134 volts at 2.5 amps), overcurrent protection device 106 measured 0.0372 Ω (resulting in a voltage drop of 0.093 volts at 2.5 amps), cell protection device 104 measured 0.042 Ω (resulting in a voltage drop of 0.105 volts at 2.5 amps), and internal cell resistance 102 measured 0.036 Ω (resulting in a voltage drop of 0.09 volts at 2.5 amps). Thus, at the point in time when the measurements were taken for this sample lithium cell, the combination of resistances 102, 104, 106, 108a, and 108b measured 0.1688 Ω (resulting in a voltage drop of 0.422 volts at 2.5 amps).

As can be seen from these measurements and calculations, if battery 100 was charged at a constant current until the voltage at the charger measured 4.2 volts, (thereafter decreasing the current to hold the measured 4.2 volts at the charger), the constant voltage phase of charging would start nearly ½ Volt too early (i.e., 0.422 volts too early). This situation contributes to a long charge cycle in lithium-based batteries.

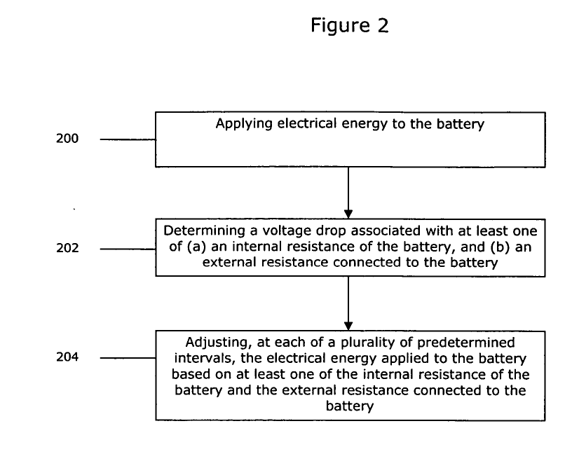

FIG. 2 is a flow diagram illustrating a method of charging a battery. At step 200, electrical energy is applied to the battery. For example, the electrical energy may be applied cyclically as a charging pulse, followed by a discharge pulse, and then a rest period. At step 202, a voltage drop associated with at least one of (a) an internal resistance of the battery, and (b) an external resistance connected to the battery is determined. For example, the voltage drop may be determined by subtracting the battery voltage measured during a no-charge period from the battery voltage measured during a charging period. At step 204, the electrical energy applied to the battery is adjusted, at each of a plurality of predetermined intervals, based on the voltage drop. For example, the electrical energy may be adjusted by modulating the period of the charging pulse.

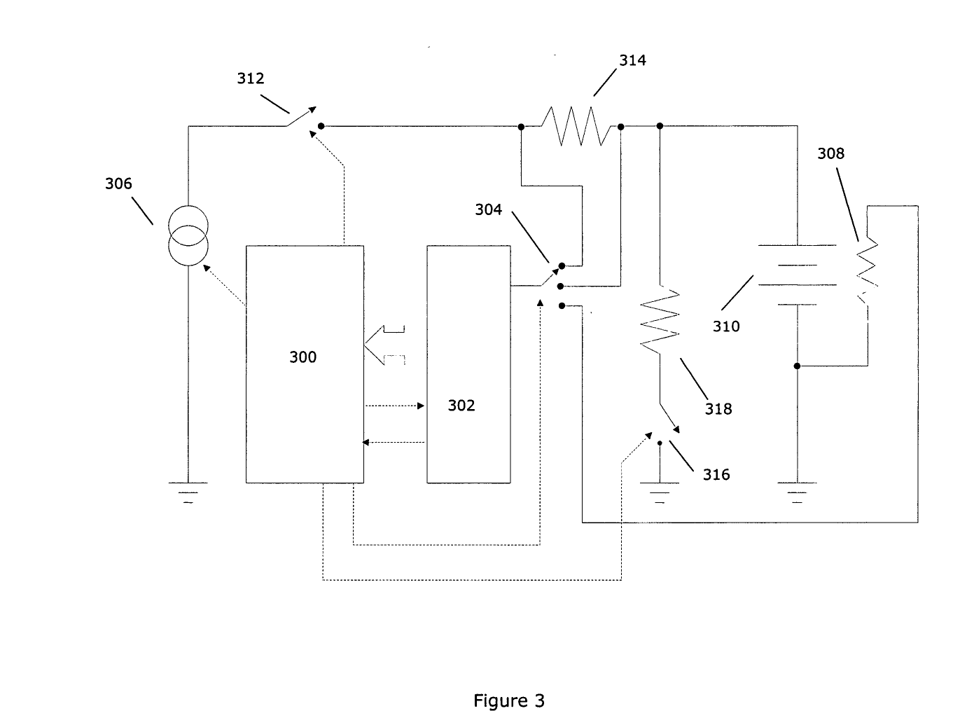

FIG. 3 is a block diagram of a battery charger control system in accordance with an exemplary embodiment of the present invention. Microcontroller 300 (e.g., a 4, 8, 16, or 32 bit microcontroller) handles all timing and sequencing functions in the charger control system. Analog to digital converter 302 converts analog signals to digital signals for processing by microcontroller 300. When a charging sequence is initiated, but before charge current is applied, microcontroller 300 sets data source switch 304 to the terminal of battery 310 (i.e., the central position of switch 304) and initiates an analog to digital conversion (e.g., a 12 bit conversion through converter 302) to read the voltage of battery 310. If the battery voltage reading is greater than or equal to 4.2 volts/cell, battery 310 is fully charged and the charging sequence is terminated. If the reading is less than 4.2 volts/cell, programmable current source 306 is set at an initial low value.

Data source switch 304 is then switched to thermistor 308 to read the battery temperature. If the measured temperature is higher than a predetermined temperature the charging process is terminated because the battery is too hot to accept charge. If the measured temperature is below the predetermined temperature, charge control switch 312 is closed to apply current from programmable current source 306 through current sense resistor 314 to battery 310. Microcontroller 300 then requests an A/D conversion (through converter 302) to measure the voltage of battery 310 under charge. Microcontroller 300 then switches data source switch 304 to the output of charge control switch 312 and the input of current sense resistor 314, and thereafter requests an A/D conversion of this total voltage value through converter 302. Microcontroller 300 then subtracts the voltage of battery 310 from this total voltage value, and based on a known resistance value of current sense resistor 314, the charging current is calculated. Microcontroller 300 then opens charge control switch 312 and measures the voltage of battery 310 under no charge. This no-charge voltage value is then subtracted from the measured voltage of battery 310 under charge. Since microcontroller 300 now has access to the charging current, and the voltage drops across the protection devices and the internal cell resistance, the actual voltage of battery 310 can be determined.

If the measured battery voltage under charge, minus the voltage drops across the various external resistances and the internal cell resistance is greater than 4.2 volts/cell, microcontroller 300 commences the constant voltage charging phase. If this value has not reached 4.2 volts/cell, the measured current is checked against a predetermined value for maximum charging current. If the measured current is less than the predetermined value, the current level provided by programmable current source 306 is incremented. If the current is greater than the predetermined value, the current level provided by programmable current source 306 is decremented, and microcontroller 300 returns to the beginning of the constant current charging phase. In this manner, a constant current to battery 310 is maintained until the battery voltage increases to 4.2 volts/cell. This process repeats at predetermined intervals, for example, at approximately a one second interval. This process is dynamic to account for the fact that the battery internal cell resistance constantly changes under varying charging conditions.

When the calculated battery voltage reaches 4.2 volts/cell, the control system moves into the constant voltage charging phase. In this constant voltage charging phase the thermistor is checked for over temperature, and the charging sequence is terminated if battery 310 is too hot to accept charge. If the temperature is below a high temperature threshold microcontroller 300 switches data source switch 304 to measure the voltage of battery 310 under charge, and then measures the voltage at the output of charge control switch 312, and then subtracts the battery voltage to determine the charging current. Microcontroller 300 then opens charge control switch 312, and switches data source switch 304 to measure the open circuit voltage of battery 310. If the voltage of battery 310 is still greater than 4.2 volts/cell the charging cycle returns to the beginning of the constant voltage charging phase. If the voltage of battery 310 is not greater than 4.2 volts/cell, microcontroller 300 increments the charging current using programmable current source 306.

After entering the constant voltage phase of the charging cycle, microcontroller 300 checks the charging current value it measured against a preset limit (e.g., 10% of battery capacity). If the measured charging current value is less than the preset value, the charging cycle is complete and fast charging is terminated. If the measured charging current value is greater than the preset value, the charging cycle returns to the beginning of the constant voltage charging phase. The overall effect of this process is to maintain a constant 4.2 volts/cell while decreasing charging current to maintain this voltage. When the battery current reaches the preset limit for terminating charge, the controller ends fast charging, and charging of battery 310 is complete. Until charging is complete, this cycle is updated at predetermined intervals, for example, at approximately a one second interval.

The charging method described above with reference to FIG. 3 results in the charger system remaining in the constant current phase of the charging cycle longer as the constant voltage phase of charging is not started until the actual battery voltage reaches approximately 4.2 volts/cell. This desirably results in reduced charging times. For example, laboratory testing has indicated a reduction in charging time from 2½-3½ hours using traditional charging methods to one hour according to the present invention.

Referring again to FIG. 3, discharge control switch 316 is controlled by microcontroller 300 to cause a short (e.g., 5 milliseconds) but deep (e.g., 2½ times the charging current maximum) discharge pulse to be applied to battery 310 periodically during the charging cycle. The discharge current of the discharge pulse is controlled by discharge resistor 318. The discharge pulse occurs on each measurement cycle (e.g., once per second) and equalizes the charge distribution over the surface of the battery plates. This pulse helps to maintain a low cell resistance and improves charge acceptance. Although using this discharge pulsing feature is not necessary to reduce charging times according to the present invention, it can greatly improve cycle life of the battery, as cell resistance will not increase with each charging cycle. For example, laboratory testing indicates that the use of this discharge pulse has resulted in cycle life performance of lithium-ion batteries in excess of 4800 charge/discharge cycles as opposed to the 350 to 500 charge/discharge cycles expected from battery manufacturers test data.

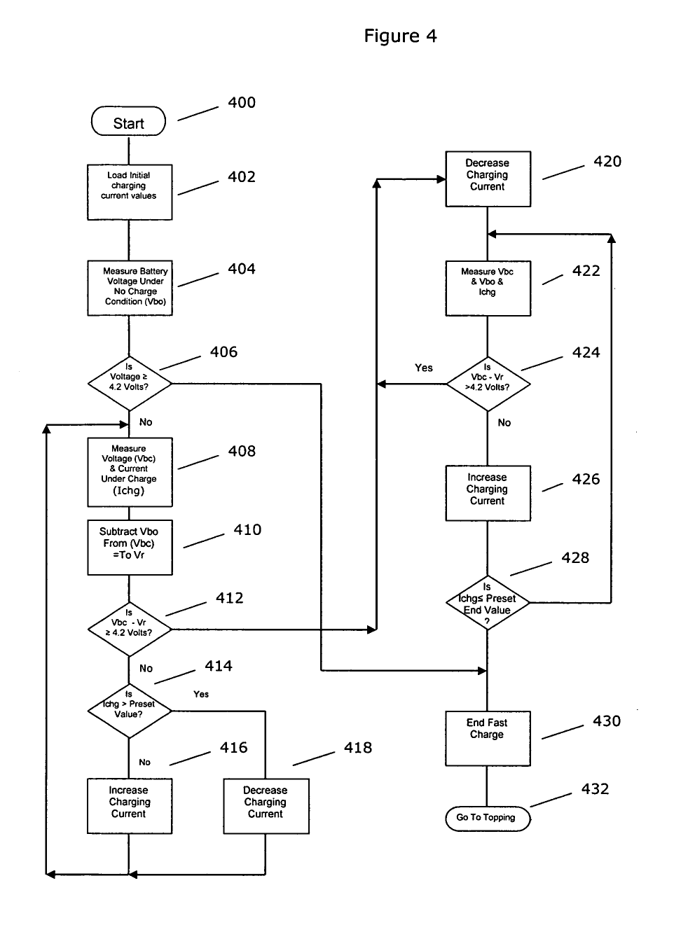

FIG. 4 is a flow diagram illustrating an exemplary method of charging a battery according to the present invention. At step 400, the charging process (e.g., a charging algorithm) is commenced. At step 402, initial current values for charging the battery are loaded. At step 404, the battery voltage is measured under a no-charge condition (i.e., V_{bo}), and at step 406, a determination is made as to whether the battery voltage measured at step 404 is greater than or equal to 4.2 volts. If the voltage is greater than or equal to 4.2 volts, the process proceeds to step 430, where the fast charge cycle is terminated. If the voltage is less than 4.2 volts, the process proceeds to step 408.

At step 408, the voltage of the battery under charge is measured (i.e., V_{bc}), as well as the current under charge (i.e., I_{chg}). At step 410, the voltage drop across the various series resistances (i.e., Vᵣ) is determined by subtracting V_{bo} from V_{bc}. At step 412, a determination is made regarding whether V_{bc} minus Vᵣ is greater than or equal to 4.2 volts. If V_{bc} minus Vᵣ is greater than or equal to 4.2 volts, then the charging process proceeds to step 420 (the beginning of the constant voltage charging phase) where the charging current is decreased. If V_{bc} minus Vᵣ is less than 4.2 volts, then the charging process proceeds to step 414.

At step 414, a determination is made as to whether I_{chg} is greater than a predetermined current value. If I_{chg} is greater than the predetermined current value, then the process proceeds to step 418 where the charging current is decreased. If I_{chg} is not greater than the predetermined current value, then the process proceeds to step 416 where the charging current is increased. From either of steps 416 or 418, the process returns to step 408.

As indicated above, if V_{bc} minus Vᵣ is greater than or equal to 4.2 volts at step 412, then the charging process proceeds to step 420 where the charging current is decreased. Following step 420, I_{chg}, V_{bo}, and V_{bc} are measured at step 422. Using these measurements, a determination is made at step 424 regarding whether V_{bc} minus Vᵣ is greater than or equal to 4.2 volts. If V_{bc} minus Vᵣ is greater than or equal to 4.2 volts at step 424, then the charging process returns to step 420 where the charging current is again decreased. If V_{bc} minus Vᵣ is less than 4.2 volts, then the charging current is increased at step 426.

From step 426, the process proceeds to step 428 where a determination is made as to whether I_{chg} is less than or equal to a preset end current value (e.g., approximately 10% of the full charging current). If I_{chg} is less than or equal to the preset end current value, the process proceeds to step 430 where the fast charge process is terminated, from which the process proceeds to applying a topping charge to the battery at step 432, If I_{chg} is greater than the preset end current value, the process returns to step 422.

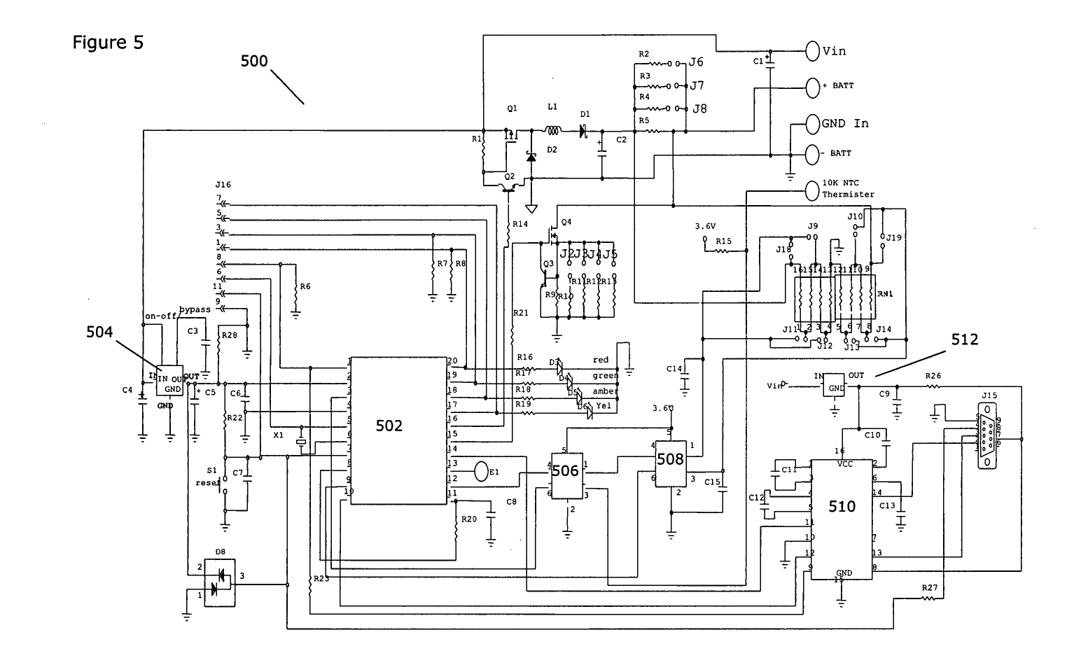

FIG. 5 is a schematic of exemplary circuitry used in connection with the charging process of the present invention. This circuitry is exemplary in nature, and as such, the present invention is not limited to this circuit. Further, many of the features illustrated in FIG. 5 may not be used in a circuit embodying a more basic configuration of the present invention.

Circuit 500 includes microcontroller 502. For example, microcontroller 502 may be a Texas Instruments model TI MSP430, version MSP430F1121. Such a microcontroller may be selected based on cost, and the fact that it is flash programmable which allows changes to the algorithm in-circuit. Further, the MSP430F1121 version contains an analog comparator which makes it easy to implement a precise analog to digital conversion (A/D). The MSP430F1121 version is a 16 bit microcontroller allowing development of the various mathematical routines. Further still, there is a family of software compatible with versions of this Texas Instruments controller which allow for development of more sophisticated versions of the control system as desired. Finally, this exemplary microcontroller uses very little power, and as such, it can be used in systems where the charging system is embedded in the battery pack.

Of course, any of a number of the commercially available microcontrollers (e.g., 4, 8, or 16 bit microcontrollers) could be used to implement an algorithm corresponding to the charging methods of the present invention. Further, code could be written for a 32 bit microprocessor such as the Pentium series, Dragonball, or any of the RISC processors used in cell phones, PDAs, or other embedded applications. In such an embodiment, certain means could be used to implement the A/D function, however, this could be external to the microcontroller or microprocessor.

Referring again to circuit 500 in FIG. 5, an external source of power is connected to the Vᵢₙ connector at the top right hand portion of circuit 500. For example, the power source may be a filtered, but not necessarily regulated, source of voltage, preferably at least 2 volts greater than the desired battery charging voltage. This power is connected to regulator 504 (e.g., a low drop out regulator) that supplies DC power to microcontroller 502. For example, the voltage supplied may be 3.6 volts DC, and in such an embodiment, an exemplary regulator 504 is National Semiconductor model LP2985AIM-3.6.

Resistor R28 is connected between the output of regulator 504 and ground, as regulator 504 typically supplies at least 1 mA to stay in regulation. The output of regulator 504 also connects to pin 2 of microcontroller 502 (pin 2 is the Vcc or power supply pin). Connector 316 is provided to implement programming (e.g., Joint Test Action Group programming (i.e., JTAG)) of microcontroller 502, as are R6, R7, and R8. Resistor R22 is connected from the output of regulator 504 to pin 7 of microcontroller 502. Resistor R22 is also connected to switch S1 (e.g., a normally open switch) which is connected to ground, and which permits manual reset of microcontroller 502. Pin 7 of microcontroller 502 is the non-maskable reset pin for microcontroller 502, and is used to reset the processor.

In addition to being connected to regulator 504, Vᵢₙ is also connected to the source of transistor Q1. For example, Q1 may be a VMOS P-Channel FET, model number IRF9Z34S supplied by International Rectifier. The collector of transistor Q2 is connected to the gate of transistor Q1, and the emitter of transistor Q2 is connected to ground. For example, Q2 may be an NPN transistor model number MMBT2222A supplied by Diodes Inc. When pin 15 of microcontroller 502 goes to a logical high state, transistor Q2 turns on through resistor R14 which connects pin 15 to the base of transistor Q2. This operation turns transistor Q1 on, thereby permitting current to flow through this VMOS FET and ultimately to the battery under charge via the +BATT connector. Resistor R1 turns transistor Q1 off when this signal is not applied. A pulse width modulator internal to microcontroller 502 turns this signal on and off at pin 15 at a constant rate (e.g., 50 KHz) when this function is enabled, however the duty cycle of this pulse is continuously variable so that the average amount of current passed by the VMOS FET can be controlled by this duty cycle. The drain electrode of transistor Q1 is connected to inductor L1. Current flows through inductor L1 and through Schottky diode D1, which prevents the battery from discharging through this path. For example, Schottky diode D1 may be a model number 10BQ015 supplied by International Rectifier.

Current continues through resistors R2, R3, R4, and R5, depending on which of these resistors is jumpered into the circuit. Capacitor C2 is provided as an energy storage element. When the current is turned off by the VMOS FET, the magnetic field around inductor L1 collapses. The end of inductor L1 connected to the VMOS FET attempts to go negative; however, Schottky catch diode D2 prevents this point from going below ground, and the energy stored in inductor L1 is delivered to the battery. For example, Schottky diode D2 may be a model number 10BQ015 supplied by International Rectifier.

Pins 17, 18, 19, and 20 on microcontroller 502 are configured as output ports, and are connected to LEDs D3, D4, D5, and D6 (e.g., surface mount LEDs supplied by Stanley, Inc.) to indicate the status of the charging circuit. Resistors R16, R17, R18, and R19 limit the current through the respective LEDs. These port pins are also utilized when JTAG programming is in progress.

Resistor pack RN1 consists of 8 closely matched resistors (e.g., 10K resistors). For example, these resistors are used to divide the various input voltages to a level of between 0 and 2.6 volts, which is the maximum that the A/D scheme implemented in microcontroller 502 can utilize. By connecting a pair of jumpers, pack RN1 can be configured to allow batteries of different voltage ratings to be charged. For a single lithium-ion cell with a voltage rating of 4.2 volts, jumpers J9 and J10 could be connected. In such a configuration, the 4.2 volts present at the battery terminals is divided. Further, a similar voltage present at the input of the current sense resistors R2, R3, R4, and R5 is divided in half, which is an acceptable level for the A/D conversion.

Multiplexers 506 and 508 may be, for example, identical model NC7SB3157P6X analog multiplexers provided by Fairchild Semiconductor. Pins 1 and 3 are the analog inputs for multiplexers 506 and 508, and pin 4 is the analog output. The digital signal applied to pin 6 of multiplexers 506 and 508 determines which one of the inputs will appear on the output. Output port pins 9 and 3 of microcontroller 502 determine which one of the inputs is selected. The divided down voltages from resistor pack RN1 are connected to the input pins of multiplexer 508, with battery voltage applied to pin 3 and charger voltage applied to pin 1. Capacitors C14 and C15 are connected to these pins in order to filter out any noise from the switch mode current source that might result in inaccuracies in the analog to digital conversion process. The analog output is connected to pin 1 of multiplexer 506. Thermistor 514 (e.g., a 10K NTC thermistor) is connected to pin 3 of multiplexer 506, with its other terminal connected to ground. Resistor R15 is connected from the regulated supply (e.g., the 3.6 volt supply) to the lead from thermistor 514, and to pin 3 of multiplexer 506 to supply current to thermistor 514. Thermistor 514 is provided because in many applications it is desirable to know the temperature of the battery so that charging current is not applied to a battery that is too hot or too cold to charge.

The analog output of multiplexer 506 at pin 4 is connected to pin 12 of microcontroller 502 which is configured as the analog input of an on-board comparator. Capacitor C8 is connected to pin 11 of microcontroller 502, and resistor R20 is connected between pins 11 and 8 of microcontroller 502. Together, these components implement a Sigma-Delta analog to digital converter which has a 1 millivolt accuracy. This circuitry allows microcontroller 502 to accurately know the voltage present at the battery terminals, as well as the current being applied to the battery. In constant current mode, microcontroller 502 varies the duty cycle of the pulse width modulator to supply a constant current to the battery. By shutting down the current source at a predetermined interval (e.g., a one second interval), microcontroller 502 has access to the open circuit voltage of the battery. Microcontroller 502 also has access to the voltage being applied to the battery under charge, and can thus calculate the voltage drop across the various parasitic resistances in the battery pack including those related to various protection devices, as well as the internal cell resistance. When the battery reaches a voltage of 4.2 volts microcontroller 502 can decrease the applied current to maintain this voltage, and can also measure the current to determine when to terminate charging.

Pin 15 of microcontroller 502 is used as an output port to control the discharge circuitry. When pin 15 goes high, a signal is applied through resistor R21 to transistor Q4. For example, Q4 may be an NPN transistor model number MMBT2222A supplied by Diodes, Inc. This signal is only applied when transistor Q1 is disabled, and occurs at a predetermined interval (e.g., a 1 second interval) for a predetermined period (e.g., 5 milliseconds). When transistor Q4 turns on, current flows through it and through resistors R9, R10, R11, R12, and R13, depending on which of the resistors are selected by jumpers J2, J3, J4, and J5. Transistor Q3 senses the voltage drop across these resistors. For example, Q3 may be an N-Channel VMOS FET model number IRLML2502 supplied by International Rectifier. When this voltage drop approaches 0.7 volts, transistor Q3 turns on and sinks the gate drive to transistor Q4. This operation acts to implement a constant current sink. Typically, this is programmed to set a discharge current of 2½ times the rated current capacity of the battery, and helps to equalize the distribution of charge over the battery plates. This improves the battery's charge acceptance and dramatically increases cycle life of the battery.

Converter 510 (e.g., a RS232 converter) may be, for example, a model MAX232A device supplied by Maxim Semiconductor. Converter 510 serves to implement communication between the charger circuitry and an external PC (not shown in FIG. 5) which can run a software package to monitor the status of the battery charging. Through such a software package charging parameters may be modified directly through a PC interface. Further still, microcontroller 502 may be programmed via such an interface. Therefore, any PC may be used to program the microcontroller. Such a configuration may provide for remote updates to the charging algorithm via the Internet. For example, a flash programming boot loader may be integrated with microcontroller 502 to allow for such programming.

Regulator 512 (e.g., a 5 volt regulator, model LM340MP5 supplied by National Semiconductor) is provided to power converter 510. Converter 510 converts the ground logic levels present on microcontroller 502 (e.g., at 3.6 volts) to a voltage level dictated by RS232 protocol (e.g., ±12 volts). Connector 115 is the RS232 connector which connects to a PC. Pin 14 of microcontroller 502 sends signals out via converter 510 to the PC. Signals received by converter 510 are transmitted to microcontroller 502 via pin 10. Flash programming commands are transmitted via converter 510 to pin 1 of microcontroller 502.

Based on design limitations related to available channels on converter 510, the reset signal for microcontroller 502 is facilitated utilizing resistor R27 and dual diode D8 (i.e., a diode connected to limit the swing of this signal between +3.6 volts and ground). For example, dual diode D8 may be a surface mount dual diode model number MA3X153 supplied by Panasonic. Resistor R26 is connected between +5 volts and pin 7 of the RS232 connector. The function of resistor R26 is to bias this point high when a PC is not connected to the RS232 port so that the charger will work without a PC connected.

Resonator X1 (e.g., a 8.00 MHz ceramic resonator) is connected between pins 5 and 6 of microcontroller 502 to provide timing reference to microcontroller 502. Resonator X1 contains capacitors to implement an oscillator function for the timing function.

Circuit 500 illustrated in FIG. 5 is designed to be versatile, and as such, by using the appropriate software, and configuring the appropriate jumpers, circuit 500 can be used to charge a variety of battery types (e.g., nickel-cadmium, nickel-metal-hydride, lead-acid, lithium-polymer, and lithium-ion) with little or no changes to the circuitry. Because of the integral data acquisition capabilities of circuit 500, a platform for investigating the formation of new batteries is also provided.

The present invention may be embedded into an electronic device, for example, portable consumer products, power tools, audio/video products, communications products, remote control toys, cellular and cordless telephones, PDAs, portable PCs, portable instruments, and other wireless products.

The charging methods and associated algorithm may be physically implemented in several forms. For example, the algorithm and charging circuitry may be implemented in a separate charging stand similar to that which is supplied with a cell phone; however, the algorithm and charging circuitry may also be implemented within the battery pack. Further, the algorithm could be implemented in an existing controller. For example, the charging algorithm could be run on a PC or cell phone connected to the charging circuitry.

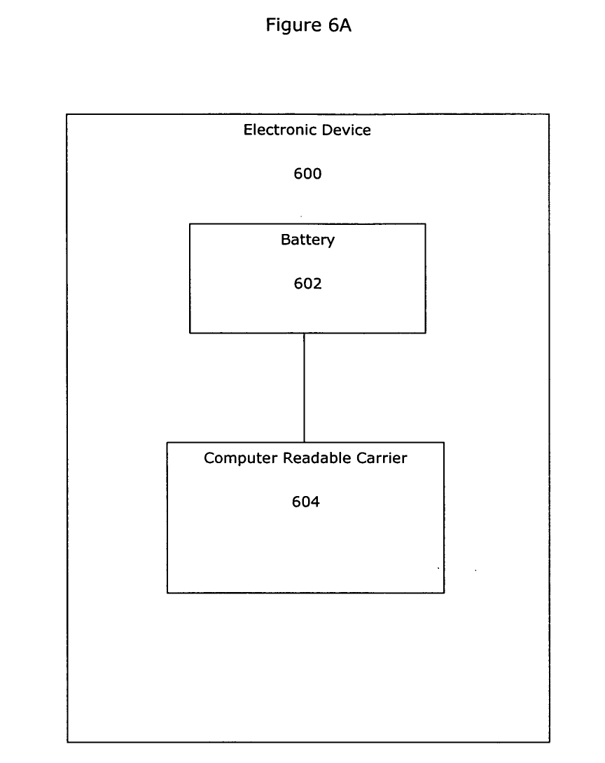

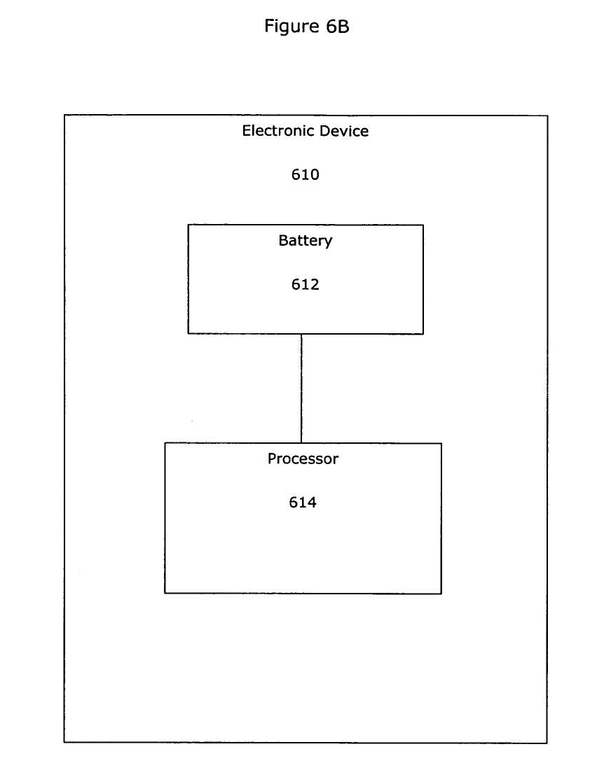

FIG. 6A is a block diagram of electronic device 600. Electronic device 600 includes battery 602 and computer readable carrier 604. Computer readable carrier 604 includes computer program instructions for implementing the battery charging methods disclosed herein. As described above, electronic device 600 may be a portable computer, a PDA, a portable telephone, a radio, or any of a number of electronic devices configured for use with a rechargeable battery. Further, while electronic device 600 is illustrated as a single unit housing battery 602 and computer readable carrier 604, it is not limited thereto. For example, electronic device 600 may include a portable device (e.g., a cordless telephone handset) and a charging device (e.g., a charging stand for the handset). In such an embodiment, battery 602 would be provided in the cordless telephone handset; however, computer readable carrier 604 may be provided in the handset or in the separate charging stand.

FIG. 6B is a block diagram of electronic device 610. Electronic device 610 includes battery 612 and processor 614. Processor 614 controls an electrical energy source (not shown in FIG. 6B) for applying electrical energy to battery 612. Further, processor 614 adjusts, at each of a plurality of predetermined intervals, the electrical energy applied to battery 612 based on at least one of an internal resistance of the battery and an external resistance connected to the battery. As described above with respect to FIG. 6A, electronic device 610 may include a portable device (e.g., a cordless telephone handset) and a charging device (e.g., a charging stand for the handset). In such an embodiment, battery 612 would be provided in the cordless telephone handset; however, processor 614 may be provided in the handset or in the separate charging stand.

According to certain embodiments of the present invention, the charging techniques described herein are implemented as part of a four stage charging sequence. During the first stage, the current level is gradually increased up to the user selected fast charge rate (e.g., during the first two minutes). During the second stage (i.e., the fast charge stage), the battery is charged until termination. During the third stage, a reduced duty cycle topping charge is applied. This is followed by the fourth stage, where a further reduced cycle maintenance charge is applied to the battery.

Regarding the first stage, it is noted that new batteries, over-discharged batteries, and batteries out of long term storage, all tend to exhibit an initial high impedance to charging. This high impedance condition can cause a voltage peak (and a −ΔV condition) at the beginning of the charge cycle that can appear to be the response of an already fully charged battery. In order to counter this condition, a conditioning charge is initially applied during the first phase. This charge eases batteries into the fast charge stage by gradually increasing the duty cycle of the charge. This gradual increase alleviates the voltage peak and the −ΔV condition. The duty cycle of the applied current is increased to the fast charge rate, by extending the current pulse on every cycle until the cycle occurs at a predetermined duration (e.g., 1.1 seconds) with a current pulse having a predetermined period (e.g., approximately 200 ms).

In the second stage, the microcontroller (e.g., microcontroller 502 illustrated in FIG. 5) applies the charging current in a repetitive sequence consisting of positive current charging pulses followed by a rest time and voltage acquisition time. This cycle (including charge, rest, and data acquisition period) is repeated at a predetermined frequency (e.g., every 1.1 seconds) until the battery is fully charged, and is sometimes referred to as the constant current phase of the charging cycle.

The amplitude of the current pulse is determined by system parameters such as the current capability of the charging system, the desired recharge time, battery capacity, and the ability of the battery to accept the charge current in the charging environment.

A voltage acquisition window immediately follows a brief rest time after the charge pulse is applied. No charge is applied during the rest time or during the acquisition window, thereby allowing for the battery chemistry to settle. Since no current is flowing, the measured cell voltage is not obscured by any internal or external voltage drop or noise. The microcontroller takes samples of the battery voltage during the acquisition window. The voltage samples may be averaged for comparisons to previous and subsequent averages in order to provide a more accurate representation of the true state of charge of the battery. This process continues as disclosed herein until the battery is charged.

During the third stage, a topping charge is applied at a rate low enough to prevent cell heating, but high enough to equalize cells in a multiple cell pack. Such a topping charge is not necessarily applied before the charged battery is put into service after the fast charge process (the second stage) is complete.

The topping charge is applied for a predetermined period (e.g., two hours). The current may be applied using a similar pulsing technique to that described above in connection with the fast charge stage; however, the delay time is likely extended during the third stage. Extending the delay time between charge pulses allows the same charging current to be used in the third stage as was used in the fast charge stage, so that no changes to the current source are necessary. For example, the same charge pulse that occurs every second at a 1C (1 hour) fast charge rate may occur every eleven (11) seconds for a topping charge rate of C/11.

During the fourth stage a maintenance charge is applied to offset the natural self-discharge of certain batteries (e.g., Ni—Cd, Ni-MH) by keeping the cells primed at peak charge. After the topping charge period ends, the microcontroller begins the maintenance charge stage by further extending the delay time between charge pulses, for example, by a factor of 4.

In order to provide further insight into certain aspects of the present invention, an exemplary charging method including additional details of the charging process, as well as exemplary data values, is now described. Initially, certain information is desirably known to proceed with the charging process. This information includes the battery type, the number of cells to be charged, and the maximum allowed charging current. Such information is typically obtainable from the product data sheet for the battery.

For example, consider an exemplary situation where it is desired to charge a single cell lithium-ion battery having a maximum voltage of 4.2 volts. Further, assume a battery capacity of 2 ampere/hours, and a maximum permitted charging rate of 1C (i.e., if the battery is discharged, it can charge be charged at a 2 amp rate). Typically, such a battery is considered to be completely charged when the charging current falls to 1/10 of the 2 amp rate with 4.2 volts applied to the battery, or 200 milliamps.

As described above, the battery pack includes certain integral protection devices and other parasitic resistances that may be modeled as resistances in series with the battery. These resistances are typically of an unknown value. For example, such resistances include the parasitic terminal and lead resistances associated with the wires and terminals connected to the battery. Exemplary terminal and lead resistances on a BYD type LP103463S lithium ion battery measured 0.0536 Ω. Additionally, overcurrent protection (e.g., a PTC fuse) may be provided in series with the battery to limit maximum charge and discharge currents. An example PTC fuse measured 0.0372 Ω. Further, a semiconductor device may be integrated with the battery pack, for example, a dual MOSFET transistor and an IC to control the transistor. The purpose of such a semiconductor device is to limit the maximum voltage applied to the battery, as well as the minimum voltage that the battery can safely be discharged to. An example semiconductor device measured 0.042 Ω. Further still, the battery has an equivalent internal cell resistance. This internal cell resistance varies as a function of numerous factors, including the construction of the cell, the state of charge of the battery, the temperature of the battery, as well as other factors. A representative value for the battery in question is 0.036 Ω.

As provided above, all of these resistances make it difficult to determine the actual cell voltage if a charging current is applied. An objective of the present invention is to negate the effects of these resistances in order to more quickly charge the battery.

According to this example, the charging system is set up for a maximum current of 2 amps and a terminating current of 200 milliamps before a charge cycle is started. Further, a charging voltage of 4.2 volts is configured in the control system. If a battery with an unknown state of charge is connected to the charging system and a charging cycle was initiated, the following actions will occur.

The charging cycle commences by applying a charging current of a low value (below the terminating current) to the battery pack. The current source is then removed in order to measure the open circuit voltage of the battery pack. If this voltage is 4.2 volts or greater, the charging cycle is terminated as the battery is already fully charged. The charging cycle will remain in this low current mode for a short period of time (e.g., approximately 1 minute) to check if low current charging pulses will increase the open circuit voltage to the 4.2 volts or greater threshold.

Assuming the battery is not fully charged, the charging current is slowly ramped up while measuring the open circuit cell voltage and the charging current at a predetermined interval (e.g., once per second). The controller also measures the voltage applied to the battery terminals while the charging current is applied.

As described herein, the controller subtracts the open circuit battery voltage from the voltage measured while charging current is being applied to determine the voltage difference across the various parasitic resistances in the battery pack. If the charging voltage minus the voltage drop across this parasitic resistance is greater than or equal to 4.2 volts, the charging cycle will proceed into the constant voltage mode to maintain this voltage. During this constant voltage mode the current utilized to maintain the voltage at approximately 4.2 volts is checked. When this current falls to a predetermined level (e.g., 200 milliamps in this example), the charging cycle will be terminated. Such a situation may arise when a nearly fully charged battery is connected to the charger.

The charging cycle continues while ramping up the charging current until the measured charging current reaches the maximum charging current, in this example 2 amps. This current level is maintained, checking the open circuit voltage of the battery pack and the voltage applied to the battery terminals at the predetermined interval (e.g., once each second). When the voltage across the battery terminals minus the voltage drop across the parasitic resistances reaches 4.2 volts, the charging cycle goes into the constant voltage charging stage. The charging controller recomputes this value (i.e., the voltage across the battery terminals minus the voltage drop across the parasitic resistances) at the predetermined interval (e.g., once each second) so that changes in cell resistance which occur during the charging process may be compensated for by adjusting the electrical energy applied to the battery.

When the voltage applied across the battery terminals minus the drop across the parasitic resistances is greater than or equal to 4.2 volts, the controller starts to decrease the charging current to maintain this voltage at 4.2 volts. During this phase of charging, current applied to maintain this voltage is measured at a predetermined interval (e.g., once each second). As the charging cycle proceeds, this current will ultimately decrease to the cutoff current, in this example, 200 milliamps, where the charger will terminate the main phase of charging and go into maintenance mode.

After the terminating current value is reached, the system enters a maintenance mode, where maintenance charging occurs for a predetermined period (e.g., 1 second) on a predetermined interval (e.g., every ten seconds) with current continuing to decrease to maintain a constant 4.2 volts. The unit proceeds to do this for some predetermined duration (e.g., two hours).

After the two hours of applying a maintenance charge has transpired, a different maintenance charge is applied (e.g., applying charging current for 1 second every 40 seconds), still controlling the current to maintain 4.2 volts open circuit cell voltage. This process may continue indefinitely, with the objective being to maintain a full charge and to overcome any self-discharge that may occur.

As this charging method substantially negates the combined effect of the series resistances, the charging cycle remains in the constant current phase of charging much longer than a charger that measures cell voltage while charging current is being applied. The net result is that the battery is charged much more quickly.

Thus, the charging techniques disclosed overcome herein certain objectionable characteristics of charging certain batteries (e.g., the long charging time associated with lithium-based batteries). Charging times of lithium-based batteries utilizing the present invention are comparable with Ni-MH, and capacity fade is greatly minimized. Further, the charging techniques disclosed herein extend the utilization of lithium-based batteries to many new applications, primarily because of the reduced charging times. Further, batteries charged according to the methods disclosed herein have indicated an increase in charge (approximately 5%) as compared to traditional constant-current constant-voltage charging methods.

Because little or no additional hardware is required to utilize the present invention, no cost penalty is incurred, while a very cost competitive solution to the problem of charging lithium-ion battery packs is provided.

Although the present invention has been described primarily by reference to lithium-based batteries having a 4.2 voltage rating, it is not limited thereto. The charging methods and systems disclosed herein are applicable to various battery technologies having different voltage ratings.

Although the present invention has been described primarily in terms of hardware and software, it is contemplated that the invention could be implemented entirely (or in part) in software on a computer readable carrier such as a magnetic or optical storage medium, or an auto frequency carrier or a radio frequency carrier.

Although the invention is illustrated and described herein with reference to specific embodiments, the invention is not intended to be limited to the details shown. Rather, various modifications may be made in the details within the scope and range of equivalents of the claims and without departing from the invention.

1. A method of charging a battery having an internal resistance and an external resistance connected to the battery comprising the steps of:
applying electrical energy to the battery; and
adjusting, at each of a plurality of predetermined intervals, the electrical energy applied to the battery based on at least one of the internal resistance of the battery and the external resistance connected to the battery.

2. The method of claim 1 comprising the additional step of:
determining at least one of (a) the internal resistance of the battery, and (b) the external resistance connected to the battery.

3. The method of claim 1 comprising the additional step of:
determining a voltage drop associated with at least one of (a) the internal resistance of the battery, and (b) the external resistance connected to the battery.

4. The method of claim 3 wherein the determining step occurs when the battery is substantially neither charging nor discharging.

5. The method of claim 3 comprising the additional steps of:
(a) applying the electrical energy to the battery for a predetermined charging time period;
(b) applying a discharge pulse to the battery for a predetermined discharging time period;
(c) providing a predetermined rest period during which neither the electrical energy nor the discharge pulse is applied to the battery, and during which the determining step takes place; and
(d) repeating steps (a), (b), and (c).

6. The method of claim 3 wherein a protective device is connected to the battery and the determining step includes determining a voltage drop across the protective device.

7. The method of claim 3 wherein the battery is comprised of at least one of a terminal resistance and a lead resistance and the determining step includes determining a voltage drop across at least one of the terminal resistance and the lead resistance.

8. The method of claim 1 having a charging period and a non-charging period comprising the additional steps of:
(a) measuring the voltage of the battery during the non-charging period; and
(b) measuring the voltage of the battery during the charging period,
the electrical energy being adjusted during the adjusting step based on a difference between the voltage measured during step (a) and the voltage measured during step (b).

9. The method of claim 1 having a charging period and a non-charging period comprising the additional steps of:
(a) determining if the battery voltage during the non-charging period is greater than or equal to a predetermined threshold voltage level; and
(b) terminating a constant current portion of a charging cycle if the battery voltage during the non-charging period is greater than or equal to the threshold voltage level.

10. The method of claim 1 comprising the additional steps of:
(a) determining if a charging current being applied to the battery is greater than a predetermined current level during a constant current phase of a charging cycle of the battery;
(b) decreasing the charging current if it is determined to be above the predetermined current level; and
(c) increasing the charging current if it is determined to be below the predetermined current level.

11. The method of claim 1 comprising the additional steps of:
(a) determining if a charging current being applied to the battery is below a predetermined current level during a constant voltage phase of a charging cycle of the battery; and
(b) terminating the constant voltage phase of the charging cycle if the charging current being applied to the battery is below the predetermined current level.

12. The method of claim 1 wherein the adjusting step includes adjusting the duration of a pulse of the electrical energy applied to the battery.

13. A computer readable carrier including computer program instructions for implementing a method of charging a battery having an internal resistance and an external resistance connected to the battery, the method comprising the steps of:
applying electrical energy to the battery; and
adjusting, at each of a plurality of predetermined intervals, the electrical energy applied to the battery based on at least one of the internal resistance of the battery and the external resistance connected to the battery.

14. The computer reader carrier of claim 13 wherein the method comprises the additional step of determining a voltage drop associated with at least one of (a) the internal resistance of the battery, and (b) the external resistance connected to the battery.

15. The computer reader carrier of claim 14 wherein the method comprises the additional steps of:
(a) applying the electrical energy to the battery for a predetermined charging time period;
(b) applying a discharge pulse to the battery for a predetermined discharging time period;
(c) providing a predetermined rest period during which neither the electrical energy nor the discharge pulse is applied to the battery, and during which the determining step takes place; and
(d) repeating steps (a), (b), and (c).

16. The computer reader carrier of claim 13 wherein the method comprises the additional steps of:
(a) measuring the voltage of the battery during a non-charging period; and
(b) measuring the voltage of the battery during a charging period,
the electrical energy being adjusted during the adjusting step based on a difference between the voltage measured during step (a) and the voltage measured during step (b).

17. An electronic device comprising:
a battery having an internal resistance and an external resistance connected to the battery; and
a computer readable carrier including computer program instructions for implementing a method of charging the battery, the method comprising the steps of:
applying electrical energy to the battery; and
adjusting, at each of a plurality of predetermined intervals, the electrical energy applied to the battery based on at least one of the internal resistance of the battery and the external resistance connected to the battery.

18. The electronic device of claim 17 wherein the method comprises the additional step of determining a voltage drop associated with at least one of (a) the internal resistance of the battery, and (b) the external resistance connected to the battery.

19. The electronic device of claim 18 wherein the method comprises the additional steps of:
(a) applying the electrical energy to the battery for a predetermined charging time period;
(b) applying a discharge pulse to the battery for a predetermined discharging time period;
(c) providing a predetermined rest period during which neither the electrical energy nor the discharge pulse is applied to the battery, and during which the determining step takes place; and
(d) repeating steps (a), (b), and (c).

20. The electronic device of claim 17 wherein the method comprises the additional steps of:
(a) measuring the voltage of the battery during a non-charging period; and
(b) measuring the voltage of the battery during a charging period,
the electrical energy being adjusted during the adjusting step based on a difference between the voltage measured during step (a) and the voltage measured during step (b).

21. An electronic device comprising:
a battery having an internal resistance and an external resistance connected to the battery; and
a processor, the processor controlling an electrical energy source for applying electrical energy to the battery, and
the processor adjusting, after each of a plurality of predetermined intervals, the electrical energy applied to the battery based on at least one of the internal resistance of the battery and the external resistance connected to the battery.

22. The electronic device of claim 21 wherein the method comprises the additional step of determining a voltage drop associated with at least one of (a) the internal resistance of the battery, and (b) the external resistance connected to the battery.

23. The electronic device of claim 22 wherein the method comprises the additional steps of:
(a) applying the electrical energy to the battery for a predetermined charging time period;
(b) applying a discharge pulse to the battery for a predetermined discharging time period;
(c) providing a predetermined rest period during which neither the electrical energy nor the discharge pulse is applied to the battery, and during which the determining step takes place; and
(d) repeating steps (a), (b), and (c).

24. The electronic device of claim 21 wherein the method comprises the additional steps of:
(a) measuring the voltage of the battery during a non-charging period; and
(b) measuring the voltage of the battery during a charging period,
the electrical energy being adjusted during the adjusting step based on a difference between the voltage measured during step (a) and the voltage measured during step (b).
